(19) United States
(12) Patent Application Publication
(10) Pub. No.: US 2025/0367928 A1
(43) Pub. Date: Dec. 4, 2025

(54) LIQUID EJECTING HEAD AND LIQUID EJECTING APPARATUS

(71) Applicant: BROTHER KOGYO KABUSHIKI KAISHA, Nagoya (JP)

(72) Inventor: SYOTA FUKUMOTO, Nagoya (JP)

(73) Assignee: BROTHER KOGYO KABUSHIKI KAISHA, Nagoya (JP)

(21) Appl. No.: 19/184,016

(22) Filed: Apr. 21, 2025

(30) Foreign Application Priority Data
May 28, 2024 (JP) 2024-085941

(51) Int. Cl. B41J 2/14

(52) U.S. Cl. CPC B41J 2/14233; B41J 2002/14306; B41J 2002/14419

(57) ABSTRACT

A head includes: a common channel and a plurality of individual channels. The common channel has: a first supply port, a second supply port, a first connecting part, a second connecting part, a first path disposed between the first supply port and the first connecting part, and a second path disposed between the second supply port and the second connecting part.

A cross-sectional area orthogonal to a first direction of the first path in the common channel is smaller than a cross-sectional area orthogonal to the first direction of each of the second path in the common channel and a part, of the common channel, which is located between the first connecting part and the second connecting part.

### REFERENCE TO RELATED APPLICATIONS

This application claims priority from Japanese Patent Application No. 2024-085941 filed on May 28, 2024. The entire content of the priority application is incorporated herein by reference.

### BACKGROUND ART

A known ink-jet head (liquid ejecting head) includes: a plurality of individual channels each including a nozzle and a pressure chamber communicating with the nozzle; a manifold (common channel) communicating with the plurality of individual channels; and a damper disposed in the manifold. Since the damper is disposed in the manifold, the damper is capable of absorbing and reducing the pressure vibration of an ink in the manifold.

### SUMMARY

In order to obtain a printed item with a high-quality image, the density of the plurality of nozzles is improved, in some cases. In a case where the density of the nozzles is improved without changing the plane size of the head, such a configuration is conceivable wherein the width of the manifold is reduced in order to secure a nozzle disposition area in which the plurality of nozzles are disposed. In this case, as the density of the nozzles is improved, the number of the plurality of individual channels also increases, and thus the amount of the ink flowing from the manifold to the plurality of individual channels increases. This might cause the pressure vibration generated within the manifold to become too great to be absorbed by the damper in some cases, which in turn necessitates to attenuate the pressure vibration by another configuration.

An object of the present disclosure is to provide a technique contributing to attenuating the pressure vibration generated in a common channel.

A liquid ejecting head according to an aspect of the present disclosure includes: a common channel extending in a first direction orthogonal to an up-down direction; and a plurality of individual channels each including a nozzle and a pressure chamber communicating with the nozzle, the plurality of individual channels being aligned in the first direction, and each of the plurality of individual channels communicating with the common channel. The common channel has: a first supply port which is disposed at one end part in the first direction of the common channel and via which a liquid is supplied; a second supply port which is disposed at the other end part in the first direction of the common channel and via which the liquid is supplied; a first path disposed between the first supply port and a first connecting part which is a connection location between the common channel and an individual channel disposed at a position closest to the one end part among the plurality of individual channels in the first direction; and a second path disposed between the second supply port and a second connecting part which is a connection location between the common channel and an individual channel disposed at a position closest to the other end part among the plurality of individual channels in the first direction. A cross-sectional area orthogonal to the first direction of the first path in the common channel is smaller than a cross-sectional area orthogonal to the first direction of each of the second path in the common channel and a part, of the common channel, which is located between the first connecting part and the second connecting part.

A liquid ejecting apparatus according to an aspect of the present disclosure includes: a head including: a common channel extending in a first direction orthogonal to an up-down direction, and a plurality of individual channels each including a nozzle and a pressure chamber communicating with the nozzle, the plurality of individual channels being aligned in the first direction, and each of the plurality of individual channels communicating with the common channel; a supplying part; and a controller. The common channel has: a first supply port which is disposed at one end part in the first direction of the common channel and via which a liquid is supplied; a second supply port which is disposed at the other end part in the first direction of the common channel and via which the liquid is supplied; a first path disposed between the first supply port and a first connecting part which is a connection location between the common channel and an individual channel disposed at a position closest to the one end part among the plurality of individual channels in the first direction; and a second path disposed between the second supply port and a second connecting part which is a connection location between the common channel and an individual channel disposed at a position closest to the other end part among the plurality of individual channels in the first direction. A cross-sectional area orthogonal to the first direction of the first path in the common channel is smaller than a cross-sectional area orthogonal to the first direction of each of the second path in the common channel and a part, of the common channel, which is located between the first connecting part and the second connecting part; and the controller is configured to control the supplying part so as to supply the liquid to the first supply port and the second supply port with a same pressure.

According to the liquid ejecting head of the present disclosure, the liquid is supplied to the common channel from the both end parts of the common channel, and the liquid in the common channel flows to the plurality of individual channels. In this situation, a pressure wave generated in the common channel is attenuated in a case where the pressure wave passes through the first path with the large channel resistance. With this, the pressure vibration generated in the common channel can be attenuated.

According to the liquid ejecting apparatus of the present disclosure, the liquid is supplied to the common channel from the both end parts of the common channel, and the liquid in the common channel flows to the plurality of individual channels. In this situation, the pressure wave generated in the common channel is attenuated in a case where the pressure wave passes through the first path with the large channel resistance. With this, the pressure vibration generated in the common channel can be attenuated. Further, the pressure difference between the individual channel close to the first supply port and the individual channel close to the second supply port is reduced. With this, the ejecting characteristic from the nozzles becomes stable.

### BRIEF DESCRIPTION OF DRAWINGS

FIG. 1 is a plan view of a printer 100 including a head 1.

FIG. 2 is a block diagram depicting the electrical configuration of the printer 100.

FIG. 3 is a plan view of the head 1.

FIG. 4 is a cross-sectional view of the head 1 along a IV-IV line in FIG. 3.

FIG. 5 is a cross-sectional view of the head 1 along a V-V line in FIG. 3.

FIG. 6 is a cross-sectional view of the head 1 along a VI-VI line in FIG. 3.

FIG. 7A is a plan view of an analytic model, and FIG. 7B is a cross-sectional view along a VII-VII line of FIG. 7A.

FIG. 8 is a diagram depicting measurement positions P1 to P5 within a common channel in the analytic model.

FIG. 9A is a diagram depicting the temporal change of pressure at each of the measurement positions P1 to P5 in a case where a length in the up-down direction of a first path is 20 μm, FIG. 9B is a diagram depicting the temporal change of pressure at each of the measurement positions P1 to P5 in a case where the length in the up-down direction of the first path is 50 μm, and FIG. 9C is a diagram depicting the temporal change of pressure at each of the measurement positions P1 to P5 in a case where the length in the up-down direction of the first path is 80 μm.

FIG. 10 is a view depicting a relationship between the length in the up-down direction of the first path and the magnitude of pressure vibration.

FIG. 11 is a view depicting a relationship between channel resistance and the magnitude of pressure vibration.

FIG. 12A is a diagram depicting an image recorded by solid printing by a head in which two first paths, respectively, of two common channels are disposed adjacent to the other end in the first direction, and FIG. 12B is a diagram depicting an image recorded by the solid printing by a head in which two first paths, respectively, of two common channels are disposed on opposite sides of each other in the first direction.

### DESCRIPTION

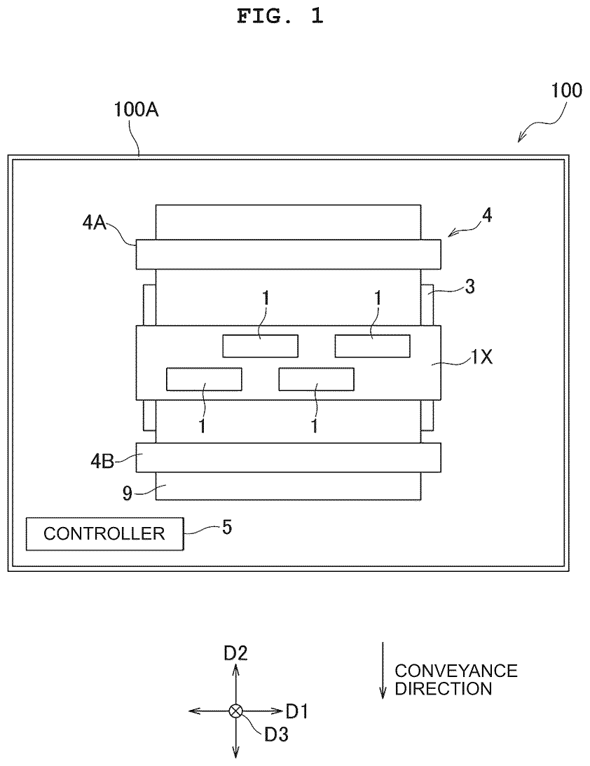

First, referring to FIG. 1, the overall configuration of a printer 100 including a head 1 according to an embodiment will be described. Note that in the following description, a first direction D1 and a second direction D2 are horizontal directions and are orthogonal to an up-down direction D3. Although the up-down direction D3 in the present embodiment is along the vertical direction, the up-down direction D3 may be an up-down direction which crosses the vertical direction and the horizontal direction. The first direction D1 is orthogonal to the second direction D2. The head 1 corresponds to a “liquid ejecting head” of the present disclosure, and the printer 100 corresponds to a “liquid ejecting apparatus” of the present disclosure.

### Overall Configuration of Printer

The printer 100 includes a casing 100A, a head unit 1X, a platen 3, a conveyor 4, and a controller 5. The head unit 1X, the platen 3, the conveyor 4, and the controller 5 are disposed in the casing 100A.

The length in the first direction D1 of the head unit 1X is longer than the length in a conveyance direction along the second direction D2 of the head unit 1X. The first direction D1 is a direction along the width of a sheet 9. The head unit 1X is fixed to the casing 100A. The type of the head unit 1X is a line system.

The head unit 1X includes four heads 1. The four heads 1 are disposed in a staggered manner in the first direction D1. The length in the first direction D1 of each of the four heads 1 is longer than the length in the second direction D2 of each of the four heads 1.

The platen 3 is a plate along a plane orthogonal to the up-down direction D3, and is disposed below the head unit 1X. The sheet 9 is supported on the upper surface of the platen 3.

The conveyor 4 has two roller pairs 4A and 4B disposed so that the platen 3 is interposed between the two roller pairs 4A and 4B in the second direction D2. In a case where a conveying motor 4C is driven under control of the controller 5, the roller pairs 4A and 4B rotate in a state that the roller pairs 4A and 4B hold the sheet 9, thereby conveying the sheet 9 in the conveyance direction along the second direction D2.

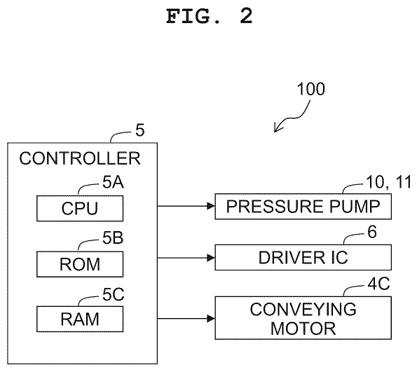

As depicted in FIG. 2, the controller 5 includes a CPU 5A, a ROM 5B, and a RAM 5C. The CPU 5A executes various kinds of control in accordance with a program and data stored in the ROM 5B and/or the RAM 5C, based on data input from an external device. The external device is, for example, a personal computer (PC).

The ROM 5B stores the programs and data with which the CPU 5A performs the various kinds of control. The RAM 5C temporarily stores data to be used in a case where the CPU 5A executes the program.

### Head

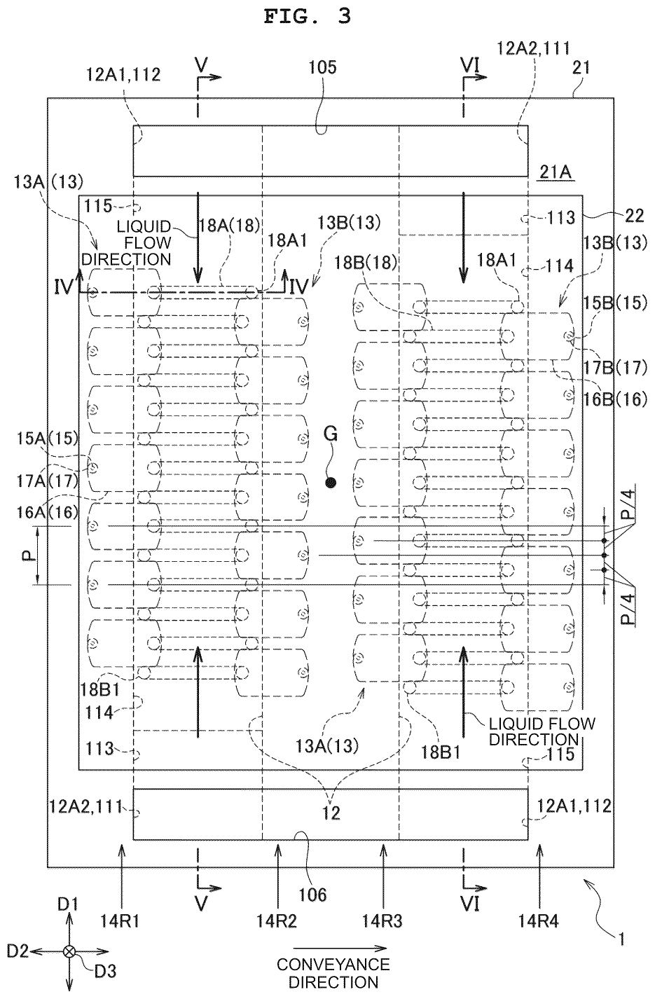

As depicted in FIG. 3, the head 1 has a channel member 21 and an actuator member 22. Both the channel member 21 and the actuator member 22 have a rectangular shape in which the length in the first direction D1 is longer than the length in the second direction D2 in a plane orthogonal to the up-down direction D3.

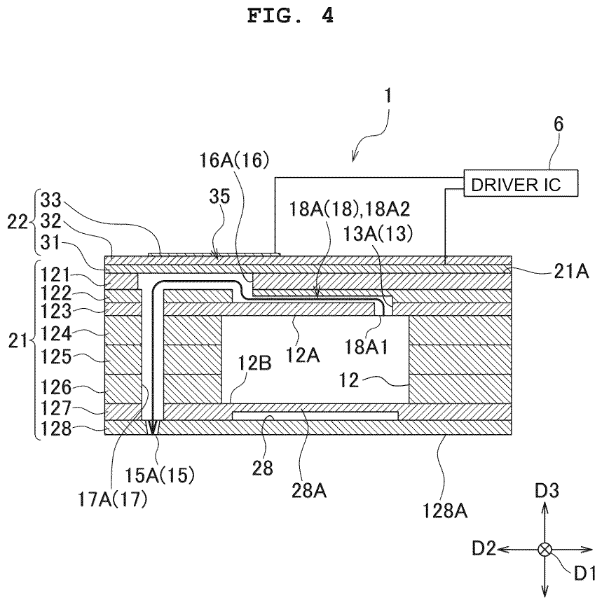

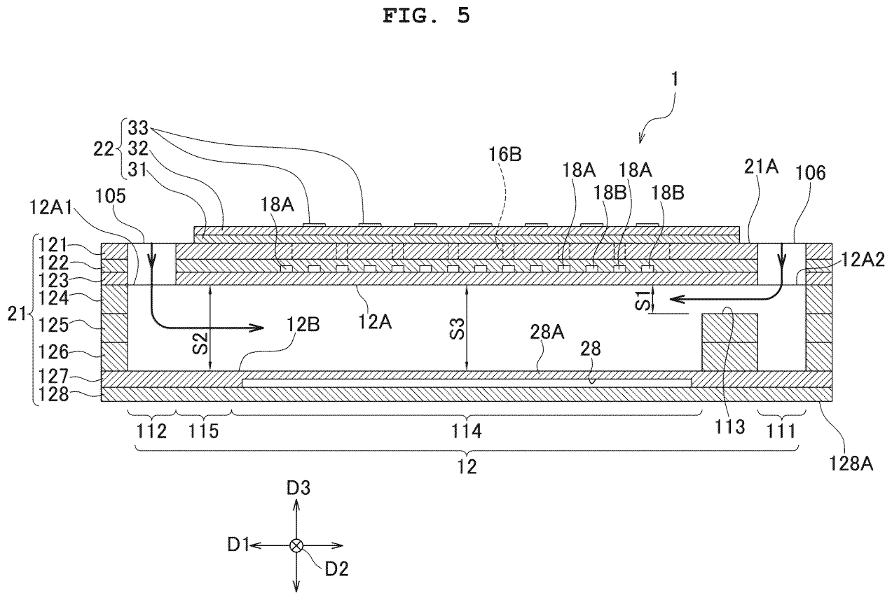

As depicted in FIG. 3, two supply ports 105 and 106 are open in an upper surface (surface) 21A of the channel member 21. The supply port 105 is disposed at one end in the first direction D1 of the channel member 21. The supply port 106 is disposed at the other end in the first direction D1 of the channel member 21. These two supply ports 105 and 106 extend in the second direction D2. Each of the supply ports 105 and 106 communicates with an ink tank via a tube. The channel member 21 has two common channels 12, a plurality of individual channels 13, and two damper chambers 28 (see FIG. 4 and FIG. 5).

The two common channels 12 are disposed side by side in the second direction D2 and extend in the first direction D1. The supply port 105 is connected to one end (upper end in FIG. 3) in the first direction D1 of each of the two common channels 12, and the supply port 106 is connected to the other end (lower end in FIG. 3) in the first direction D1 of each of the two common channels 12. Each of the two common channels 12 is connected to the ink tank and to individual channels 13, included in the plurality of individual channels 13 and corresponding each of the two common channels 12, via the two supply ports 105 and 106.

As depicted in FIG. 3, the two common channels 12 are disposed in point symmetry with respect to a center point G of the channel member 21. In other words, one of the two common channels 12 (the common channel 12 on the left side in FIG. 3) is the same as the other common channel 12 (the common channel 12 on the right side in FIG. 3) being rotated 180° with respect to the center point G. Therefore, the detailed configuration of one common channel 12 will be described below. Regarding the other common channel 12, the configuration the other common channel 12 which is the same as the configuration of the one common channel 12 is indicated by the same reference numerals, and the detailed description therefor will be omitted.

As depicted in FIG. 5, the one common channel 12 has two inflow ports 12A1 and 12A2 which are open in an upper surface 12A of the one common channel 12. The inflow port 12A1 is a part which overlaps with the supply port 105 of the one common channel 12 in the up-down direction D3, and the ink from the supply port 105 flows into the inflow port 12A1. The inflow port 12A2 is a part which overlaps with the supply port 106 of the one common channel 12 in the up-down direction D3, and the ink from the supply port 106 flows into the inflow port 12A2. The inflow port 12A1 corresponds to a “second supply port” of the present disclosure, and the inflow port 12A2 corresponds to a “first supply port” of the present disclosure.

The one common channel 12 has a first supplying part 111, a second supplying part 112, a first path 113, a common part 114, and a second path 115. The first supplying part 111 is disposed at the other end part (right end part in FIG. 5) in the first direction D1 of the one common channel 12, and the inflow port 12A2 is open above the first supply part 111. The first supplying part 111 communicates with the first path 113. The second supplying part 112 is disposed at one end part (left end part in FIG. 5) in the first direction D1 of the one common channel 12, and an inflow port 12A1 is open above the second supplying part 112. The second supplying part 112 communicates with the second path 115.

As depicted in FIG. 3, the first path 113 is disposed in the first direction D1 between the inflow port 12A2 and a connection port 18B1 of an individual channel 13 which is disposed at a position closest to the inflow port 12A2 among the individual channels 13 communicating with the one common channel 12. The second path 115 is disposed in the first direction D1 between the inflow port 12A1 and a connection port 18A1 of an individual channel 13 disposed at a position closest to the inflow port 12A1 among the individual channels 13 communicating with the one common channel 12. As depicted in FIG. 5, the common part 114 is disposed between both the first path 113 and the second path 115, with the first path 113 being connected to the other end in the first direction D1 (the right end in FIG. 5) of the common part 114 and the second path 115 being connected to one end in the first direction D1 (the left end in FIG. 5) of the common part 114. The connection port 18A1 corresponds to a “second connecting portion” of the present disclosure, and the connection port 18B1 corresponds to a “first connecting portion” of the present disclosure.

As depicted in FIG. 3, the first path 113, the common part 114, and the second path 115 all have the same length in the second direction D2. The first path 113 and the second path 115 also have the same length in the first direction D1. The common part 114 has a length in the first direction D1 which is longer than the length in the first direction D1 of each of the first path 113 and the second path 115. The first path 113 has a length in the up-down direction D3 which is shorter than the length in the up-down direction D3 of each of the common part 114 and the second path 115. The common part 114 and the second path 115 have the same length in the up-down direction D3. In this way, a cross-sectional area S1, of the first path 113, which is orthogonal to the first direction D1 is smaller than a cross-sectional area S2 and a cross-sectional area S3, respectively, of the common part 114 and the second path 115 which are orthogonal to the first direction D1, as depicted in FIG. 5. Further, the cross-sectional area S3, of the common part 114, which is orthogonal to the first direction D1 is the same as the cross-sectional area S2, of the second path 115, which is orthogonal to the first direction D1.

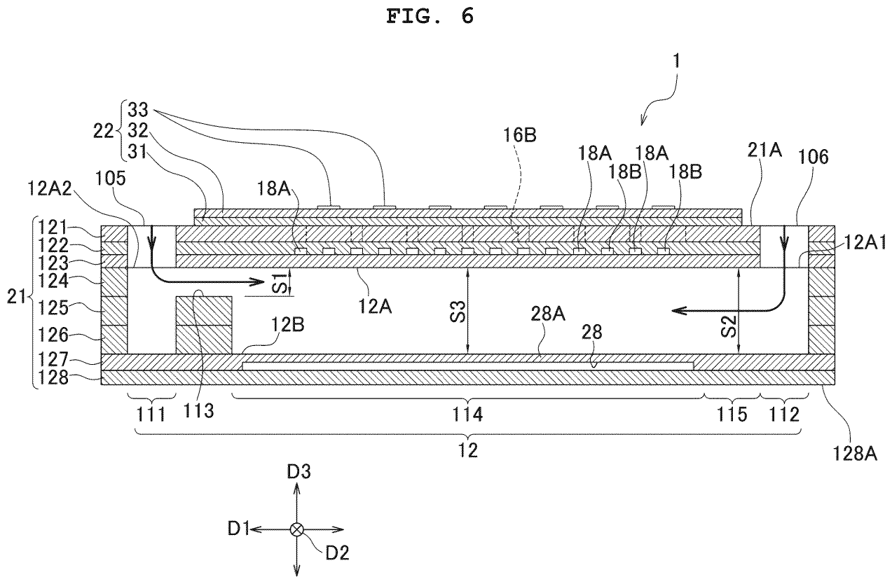

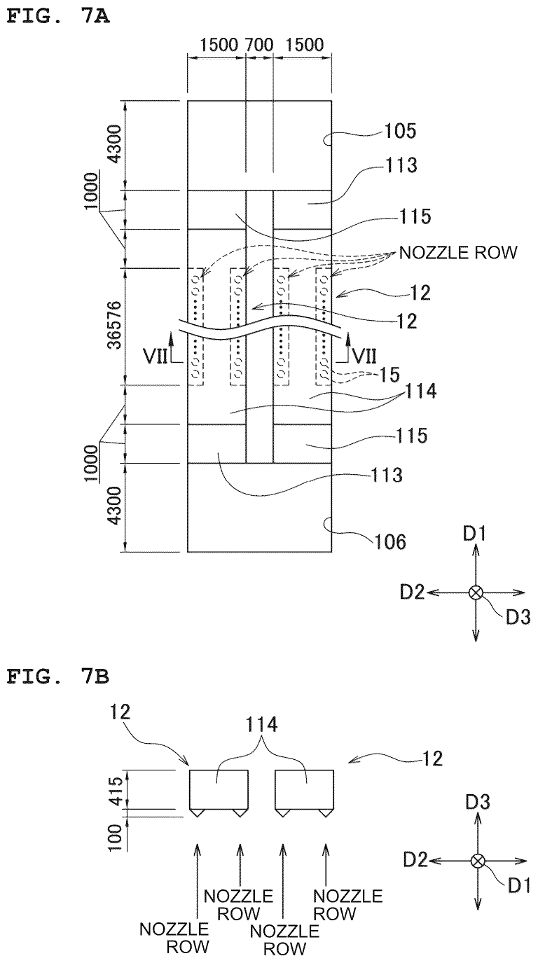

Note that the one common channel 12 and the other common channel 12 are disposed in point symmetry with respect to the center point G. Therefore, as depicted in FIG. 6, in the other common channel 12, an order by which the first supplying part 111, the second supplying part 112, the first path 113, the common part 114, and the second path 115 constructing the other common channel 12 are disposed in the first direction D1 are reversed to the order by which the first supplying part 111, the second supplying part 112, the first path 113, the common part 114, and the second path 115 are disposed in the first direction D1 in the one common channel 12. In other words, in the other common channel 12, the ink from the supply port 106 flows into the inflow port 12A1, and the ink from the supply port 105 flows into the inflow port 12A2. The inflow port 12A1 is a part which overlaps with the supply port 106 of the other common channel 12 in the up-down direction D3, and the inflow port 12A2 is a part which overlaps with the supply port 105 of the other common channel 12 in the up-down direction D3.

Further, as depicted in FIG. 3, the first path 113 is disposed in the first direction D1 between the inflow port 12A2 and the connection port 18A1 of an individual channel 13 disposed at a position closest to the inflow port 12A2 among the individual channels 13 communicating with the other common channel 12. The second path 115 is disposed in the first direction D1 between the inflow port 12A1 and the connection port 18B1 of an individual channel 13 disposed at a position closest to the inflow port 12A1 among the individual channels 13 communicating with the other common channel 12. In this way, the first paths 113 of the two common channels 12 are disposed on the opposite sides to each other in the first direction D1, with the common parts 114 of the two common channels 12 being interposed between the first paths 113 of the two common channels 12. Note that the common part 114 includes an area between the connection port 18A1 or 18B1 of the individual channel 13 disposed at the position closest to the inflow port 12A2 and the connection port 18B1 or 18A1 of the individual channel 13 disposed at the position closest to the inflow port 12A1. An end part, of the common channel 12, in which the inflow port 12A1 is disposed corresponds to “one end part in the first direction” of the present disclosure, and an end part, of common channel 12, in which the inflow port 12A2 is disposed corresponds to “the other end part in the first direction” of the present disclosure.

Each of the two damper chambers 28 is disposed below one of the common channels 12 corresponding thereto. The two damper chambers 28 are also disposed side by side in the second direction D2, and each extend in the first direction D1.

As depicted in FIG. 3 and FIG. 4, each of the plurality of individual channels 13 includes a nozzle 15, a pressure chamber 16, a communication channel 17, and a supply channel 18. One end of the communication channel 17 communicates with the nozzle 15, and the other end of the communication channel 17 communicates with the pressure chamber 16. One end of the supply channel 18 communicates with the common channel 12, and the other end of the supply channel 18 communicates with the pressure chamber 16.

As depicted in FIG. 4, the channel member 21 includes eight plates 121 to 128. Note that the channel member 21 may be constructed of nine or more plates, or seven or less plates. In the eight plates 121 to 128, the plate 121 which is the uppermost layer of the eight plates 121 to 128 has a plurality of pressure chambers 16 formed in the plate 121, and the plate 128, which is the lowermost layer of the eight plates 121 to 128 has a plurality of nozzles 15 formed in the plate 128. The plurality of pressure chambers 16 are located above the common channel 12.

The plurality of pressure chambers 16 are open in the upper surface (upper surface 21A) of the plate 121, and the plurality of nozzles 15 are open in the lower surface of the plate 128. In this manner, the plurality of nozzles 15 are disposed in a nozzle surface 128A which is the lower surface of the plate 128. The opening of each of the plurality of nozzles 15 is circular, and the opening of each of the plurality of pressure chambers 16 has a substantially rectangular shape which is slightly elongated in the second direction D2. In other words, the length in the first direction D1 (width) of each of the plurality of pressure chambers 16 is shorter than the length in the second direction D2 of each of the plurality of pressure chambers 16. As depicted in FIG. 4, each of the plurality of nozzles 15 has a shape tapered downward.

Further, as depicted in FIG. 5 and FIG. 6, the two supply ports 105 and 106 are open in the upper surface 21A of the plate 121. Each of the two supply ports 105 and 106 is defined by interconnecting holes formed, respectively, in the three plates 121 to 123.

As depicted in FIG. 4 to FIG. 6, each of the common channels 12 is defined by interconnecting holes formed, respectively, in the three plates 124 to 126. The first path 113 included in the common channel 12 is defined by a part of a hole formed in the plate 124, and the first path 113 is disposed along the upper surface 12A of the common channel 12. The first supplying part 111, the second supplying part 112, the common part 114, and the second path 115 included in the common channel 12 which are other than the first path 113 are defined by interconnecting holes formed, respectively, in the three plates 124 to 126. Each of the common channels 12 overlaps with all the pressure chambers 16 communicating with each of the common channels 12 in the up-down direction D3.

Each of the two damper chambers 28 is defined by closing a recessed part formed in the plate 127 with the plate 128. An upper part, of the damper chamber 28 of the plate 127, which is interposed between each of the damper chambers 28 and the common channel 12, functions as a damper 28A configured to absorb pressure vibration of the ink in one of the common channels 12. In other words, the damper 28A is disposed along the bottom surface 12B of the common channel 12, and even in a case where pressure generated in a certain pressure chamber 16 during the ejection of ink from the nozzle 15 propagates to the common channel 12, the damper 28 elastically deforms to thereby attenuate the pressure, thereby reducing the occurrence of a phenomenon wherein the pressure is propagated to another pressure chamber 16 (so-called crosstalk). Further, the damper 28A is configured to also absorb, to some extent, pressure vibration generated by the ink flowing from the common channel 12 to the individual channel 13 due to the ejection of ink from the nozzle 15.

As depicted in FIG. 3, the plurality of individual channels 13 are aligned in the first direction D1, constructing four individual channel rows 14R which are first individual channel row 14R1 to fourth individual channel row 14R4. These four individual channel rows 14R are disposed side by side in the second direction D2. Further, individual channels 13 included in the plurality of individual channels 13 and belonging to two individual channel rows 14R which are included in the four individual channel rows 14R (14R1 to 14R4) and which are adjacent in the second direction D2 are disposed to be shifted from each other in the first direction D1. The four individual channel rows 14R (14R1 to 14R4) correspond to the two common channels 12 such that two individual channels 14R correspond to one of the two common channels 12. The first individual channel row 14R1 to the fourth individual channel row 14R4 are disposed in this order from upstream to downstream in the conveyance direction.

Each of the first individual channel row 14R1 and the third individual channel row 14R3 has a plurality of individual channels 13A aligned in the first direction D1. Each of the second individual channel row 14R2 and the fourth individual channel row 14R4 has a plurality of individual channels 13B aligned in the first direction D1. The plurality of individual channels 13A and the plurality of individual channels 13B have the same channel configuration including the channel shape and size. More specifically, each of the individual channels 13A included in the first individual channel row 14R1 and one of the individual channels 13B included in the second individual channel row 14R2 are disposed in point symmetry with respect to the midpoint of a line segment connecting the nozzles 15 belonging, respectively, to the individual channel 13A and the individual channel 13B, in the plane orthogonal to the up-down direction D3. Each of the individual channels 13A included in the third individual channel row 14R3 and one of the individual channels 13B included in the fourth individual channel row 14R4 are also disposed in point symmetry with respect to the midpoint of a line segment connecting the nozzles 15 belonging, respectively, to the individual channel 13A and the individual channel 13B, in the plane orthogonal to the up-down direction D3.

In the following, the detailed configuration of each of the individual channels 13A will be described, whereas the detailed configuration of each of the individual channels 13B will be omitted.

As depicted in FIG. 4, each of the individual channels 13A includes a nozzle 15A, a pressure chamber 16A, a communication channel 17A, and a supply channel 18A. Note that as depicted in FIG. 3, each of the individual channels 13B also includes a nozzle 15B, a pressure chamber 16B, a communication channel 17B, and a supply channel 18B, and is disposed at the same height level as the individual channel 13A.

The communication channel 17A extends upward from the nozzle 15A in the up-down direction D3 and is connected to a lower end of the pressure chamber 16A. The communication channel 17A is defined by interconnecting the holes formed, respectively, in the six plates 122 to 127, and has a diameter greater than the diameter of the nozzle 15A.

Further, the nozzle 15A is disposed immediately below the communication channel 17A. Furthermore, the nozzle 15A overlaps with the pressure chamber 16A in the up-down direction D3. Moreover, the nozzles 15A are disposed, in the second direction D2, outside the common channel 12 with which the nozzles 15 communicate.

The supply channel 18A is defined by interconnecting holes formed, respectively, in the two plates 122 and 123. Further, one end of the supply channel 18A is connected to an upper end of the common channel 12, and the other end of the supply channel 18A is connected to a lower end of the pressure chamber 16A (an end part, of the pressure chamber 16A, on the opposite side to the communication channel 17A).

Further, as depicted in FIG. 3 and FIG. 4, the supply channel 18A is connected to the common channel 12 via a connection port 18A1 which is a connection location between the individual channel 13A and the common channel 12 and which is open in the common channel 12. Note that the supply channel 18B of the individual channel 13B is connected to the common channel 12 via a connection port 18B1 which is a connection location between the individual channel 13B and the common channel 12 and which is open in the common channel 12, as depicted in FIG. 3.

Furthermore, the supply channel 18A has a throttle part 18A2. The throttle part 18A2 is defined by blocking a groove formed in the plate 122 with the plate 123. A cross-sectional area, of the throttle part 18A2, which is orthogonal to a liquid flow direction (first direction D1) is smaller than the area of opening of the connection port 18A1.

In each of the individual channel rows 14R, as depicted in FIG. 3, the nozzles 15, of the plurality of nozzles 15, which are included in each of the individual channel rows 14R, are disposed at a predetermined pitch P in the first direction D1. Further, all the plurality of nozzles 15 are disposed at mutually different positions in the first direction D1. Among the plurality of nozzles 15, two nozzles 15 which are adjacent to each other in the first direction D1 are disposed to be apart from each other in the first direction by ¼ the pitch P. As a result, in a case where the recording resolution at the pitch P is 300 dpi, the recording resolution of 1200 dpi is realized by all the plurality of nozzles 15.

During the printing, the two pressure pumps 10 and 11 depicted in FIG. 2 are driven under the control of the controller 5, whereby the ink in the ink tank is supplied to the common channels 12 via the two supply ports 105 and 106, and the ink is distributed from each of the common channels 12 to the individual channels 13. In other words, the both end parts in the first direction D1 of each of the common channels 12 are connected, respectively, to the different pressure pumps 10 and 11. More specifically, the pressure pump 10 communicates with the supply port 105, and is controlled by the controller 5 so that a predetermined pressure (negative pressure) is applied to the ink in the supply port 105. The pressure pump 11 communicates with the supply port 106, and is controlled by the controller 5 so that a predetermined pressure (negative pressure) which is of the same magnitude as the magnitude of the predetermined pressure applied to the ink in the supply port 105 is applied to the ink in the supply port 106. In a case where ink is ejected from the nozzles 15 during the printing, the ink is supplied from the common channel 12 to the individual channels 13. Further, as depicted in FIGS. 5 and 6, the ink from the two supply ports 105 and 106 is supplied to the common channel 12 via, respectively, the two inflow ports 12A1 and 12A2. Each of the pressure pumps 10 and 11 corresponds to a “supplying part” of the present disclosure.

Furthermore, in a case where the ink in the ink tank is initially introduced to the head 1, the two pressure pumps 10 and 11 apply mutually different pressures to the ink in the supply ports 105 and 106, under the control of the controller 5. That is, the pressure pump 10 is controlled by the controller 5 so as to apply a first pressure (negative pressure) to the ink in the supply port 105, and the pressure pump 11 is controlled by the controller 5 so as to apply a second pressure (negative pressure) smaller than the first pressure to the ink in the supply port 106. By such a pressure difference, the ink supplied from the supply port 105 moves inside the common channel 12, from the inflow port 12A1, from the one end toward the other end in the first direction D1 of the common channel 12, and reaches the supply port 106 from the inflow port 12A2. The ink which reaches the supply port 106 is returned to the ink tank via the tube. In this manner, the initial introduction of the ink to the head 1 is performed. In this situation, the first path 113 is disposed along the upper surface 12A of the common channel 12. Owing to this, an air bubble in the common channel 12 can be easily exhausted. In such a presumed case where the first path 113 is disposed away from the upper surface 12A, the air bubble might easily accumulate between the upper surface 12A and the first path 113 in the up-down direction D3. However, in the configuration of the present embodiment, the air bubble can be easily exhausted and therefore is less likely to accumulate in the common channel 12.

In a case where ink is ejected from the nozzles 15 and the ink in the common channel 12 flows into the individual channels 13, a pressure wave is generated in the common channel 12. The pressure wave propagates in the common channel 12 in the first direction D1, and the pressure vibration is generated in the common channel 12. Since the cross-sectional area SI of the first path 113 is smaller than the cross-sectional area S2 and the cross-sectional area S3 of, respectively, the common part 114 and the second path 115, the channel resistance of the first path 113 is greater than the channel resistance of each of the common part 114 and the second path 115. Therefore, the pressure wave generated in the common channel 12 is attenuated in a case where the pressure wave passes through the first path 113. With this, the pressure vibration generated in the common channel 12 can be attenuated.

In the individual channel 13, the volume of the pressure chamber 16 is reduced by driving of an actuator part 35 (to be described later), and the pressure is applied to the ink in the pressure chamber 16, causing the ink to pass through the communication channel 17 and be ejected from the nozzle 15 as an ink droplet of the ink.

As depicted in FIGS. 3 to 6, the actuator member 22 is fixed to the upper surface 21A of the channel member 21. As depicted in FIG. 4, the actuator member 22 includes a metallic vibration plate 31, a piezoelectric layer 32, and a plurality of individual electrodes 33.

Parts, in the actuator member 22, each of which overlaps with one of the pressure chambers 16 in the up-down direction D3 functions as actuator parts 35. Each of the actuator parts 35 can be deformed independently according to a potential applied to the individual electrode 33.

Each of the actuator parts 35 is a thin-film piezoelectric element. The thin-film piezoelectric element is a so-called micro electro mechanical systems (MEMS). The actuator parts 35 are formed by sequentially depositing, on the upper surface of the vibration plate 31, a thin film which becomes the piezoelectric layer 32, and a thin film which becomes the plurality of individual electrodes 33.

The vibration plate 31 is disposed on the upper surface 21A of the channel member 21 so as to cover the plurality of pressure chambers 16. The piezoelectric layer 32 is disposed on the upper surface of the vibration plate 31. Each of the plurality of individual electrodes 33 is disposed on the upper surface of the piezoelectric layer 32 so as to overlap with a pressure chamber 16, of the plurality of pressure chambers 16, corresponding thereto, in the up-down direction D3.

The vibration plate 31 and the plurality of individual electrodes 33 are electrically connected to a driver IC 6. The driver IC 6 maintains the potential of the vibration plate 31 at the ground potential, whereas the driver IC 6 changes the potential of each of the plurality of individual electrodes 33. The vibration plate 31 functions as a common electrode which is common to the actuator parts 35.

The driver IC 6 generates a driving pulse signal based on a control signal from the controller 5, and supplies the driving pulse signal to each of the plurality of individual electrodes 33. The driving pulse signal changes the potential of each of the plurality of individual electrodes 33 between a predetermined driving potential and the ground potential. In this manner, each of the actuator parts 35 is driven, and the pressure is applied to the ink in the pressure chamber 16, causing the ink to be ejected from the nozzle 15 through the communication channel 17.

Here, the channel resistance of the first path 113 included in the common channel 12 in the present embodiment will be described. The channel resistance of the first path 113 is set to be in a range of 1.3×10¹⁰ Pa·s/m³ to 1.9×10¹¹ Pa·s/m³. This range of 1.3×10¹⁰ Pa·s/m³ to 1.9×10¹¹ Pa·s/m³ is derived based on the analysis indicated below.

First, the two common channels 12 formed in the channel member 21 in the present embodiment are set as a simplified analytic model as depicted in FIG. 7. This analytic model is constructed of two common channels 12, four nozzle rows which are disposed so that two nozzle rows, among the four nozzle rows, are connected to the bottom surface of each of the two common channels 12. The length in the second direction D2 of each of the two common channels 12 is set to 1500 μm. Further, the length in the up-down direction D3 of each of the two common channels 12 is set to 415 μm. In other words, the length in the up-down direction D3 of each of the common part 114 and the second path 115 is 415 μm. The length in the first direction D1 of each of the first path 113 and the second path 115 is set to 1000 μm, and the length in the first direction D1 of the common part 114 is set to 38576 μm. Each of the four nozzle rows is constructed by disposing nozzles 15 along the first direction D1, and each of the four nozzle rows is disposed at a position, in the common part 114, which is 1000 μm away from each of the first path 113 and the second path 115. Note that the unit of dimensions in FIGS. 7A and 7B is all “μm”.

Further, the length in the up-down direction D3 of the first path 113 in the above-described analytical model is changed so as to derive the channel resistance of the first path 113 which can most effectively attenuate the pressure vibration in the common channel 12. An ink ejecting condition in this situation was set to eject the ink from all the nozzles 15 in each of the nozzle rows simultaneously, and to eject the ink at 0.4 pl/μs from one nozzle 15, i.e., from one individual channel 13. Furthermore, each of the four nozzle rows was constructed of 70 nozzles 15, and the same pressure was applied to the ink at the two supply ports 105 and 106 which supply the ink to each of the common channels 12.

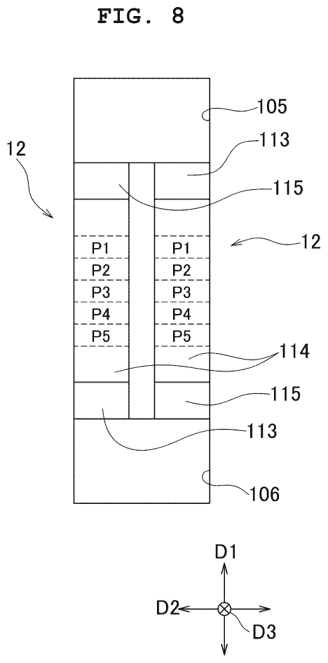

After starting the ejection of the ink under the above-described ink ejecting condition, the inner pressure was measured at measurement positions P1 to P5 of each of the common channels 12 as depicted in FIG. 8. The measurement positions P1 to P5 correspond, respectively, to five divided positions in a length area, of the common part 114 of each of the common channels 12, which corresponds to the nozzle row.

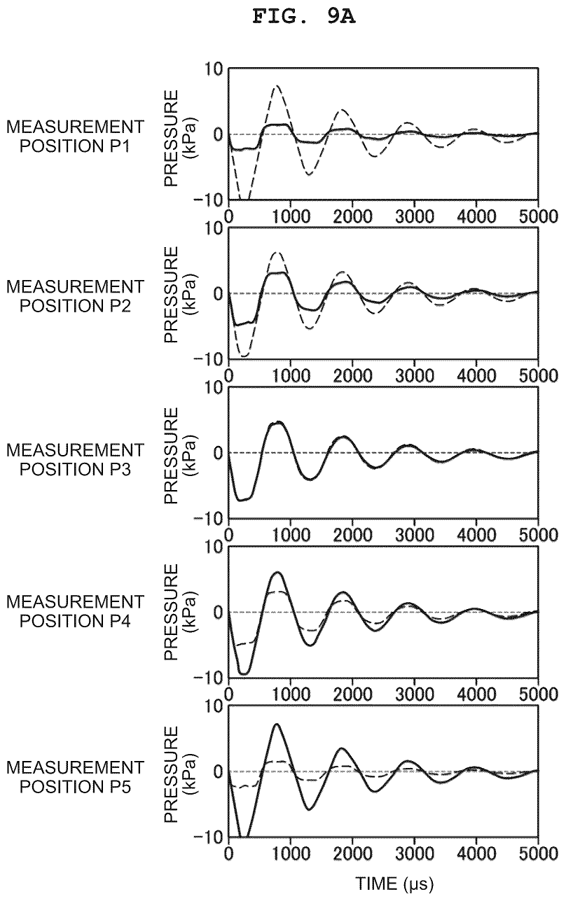

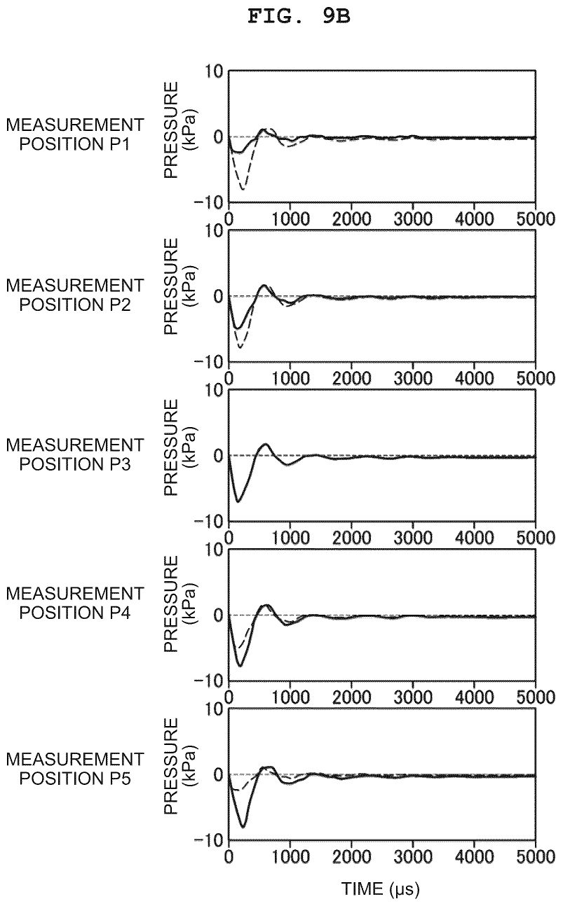

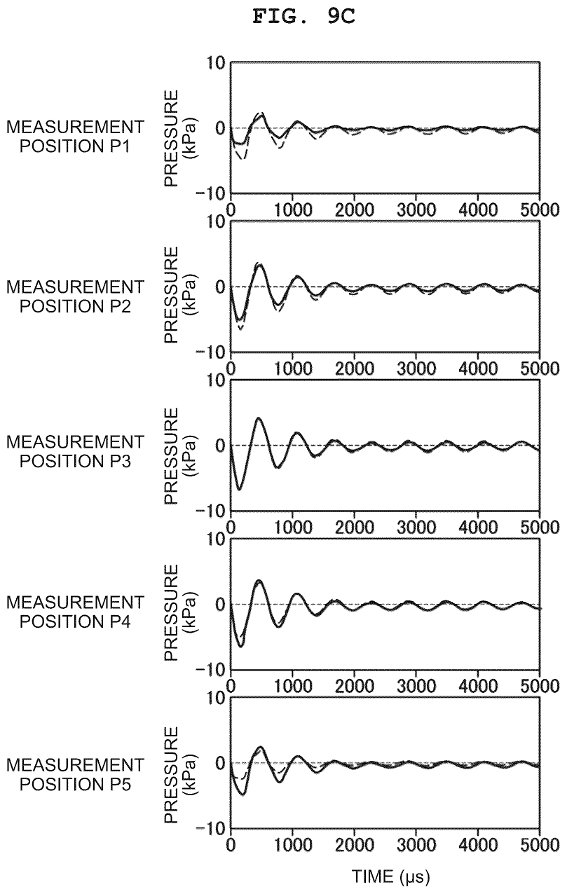

FIG. 9A depicts the temporal change of the pressure at each of the measurement positions P1 to P5 in a case where the length in the up-down direction D3 of the first path 113 is 20 μm, FIG. 9B depicts the temporal change of the pressure at each of the measurement positions Pl to P5 in a case where the length in the up-down direction of the first path 113 is 50 μm, and FIG. 9C depicts the temporal change of the pressure at each of the measurement positions P1 to P5 in a case where the length in the up-down direction of the first path 113 is 80 μm. In FIG. 9A to FIG. 9C, solid lines indicate the temporal change of the pressure in one common channel 12 (left in FIGS. 7A and 7B and FIG. 8) of the two common channels 12, and broken lines indicate the temporal change of the pressure in the other common channel 12 (right in FIGS. 7A and 7B and FIG. 8) of the two common channels 12. In the graph at each of the measurement positions P1 to P5 in FIG. 9A to FIG. 9C, the vertical axis of the graph depicts the magnitude of pressure, and the horizontal axis depicts the time.

As indicated in FIG. 9A to FIG. 9C, in the one common channel 12, the pressure value until the vibration is attenuated becomes greater from the measurement position P1 toward the measurement position P5. On the other hand, in the other common channel 12, the pressure value until the vibration is attenuated becomes smaller from the measurement position P1 toward the measurement position P5. Note that at the measurement position P3, the magnitude of the pressure value is almost the same for each of the two common channels 12.

In the case where the length in the up-down direction D3 of the first path 113 is 20 μm, the initial pressure value at each of the measurement positions P1 to P5 is great and the time is required so as to attenuate the vibration as compared with the case where the length is 50 μm or 80 μm. In the case where the length in the up-down direction D3 of the first path 113 is 80 μm, the initial pressure value at each of the measurement positions P1 to P5 is slightly smaller than in the case where the length is 50 μm, but the time is required so as to attenuate the vibration. In other words, as appreciated from FIGS. 9A to 9C that among the above-described three lengths of the first path 113, the time required for attenuating the vibration is the shortest in the case where the length is 50 μm.

Next, the range in which the pressure vibration can be effectively attenuated is obtained. The pressure vibration in each of the common channels 12 is quantified. As the method of quantifying, a value obtained by integrating the absolute value of the pressure in the direction of the time is used. For example, in a case where the pressure at a measurement position j is Pj(t), a value Sj obtained by integrating the absolute value of the pressure in each of the common channels 12 is given by the following mathematical expression:

$${S}_{j} = \int {P}_{j} ( t ) dt$$

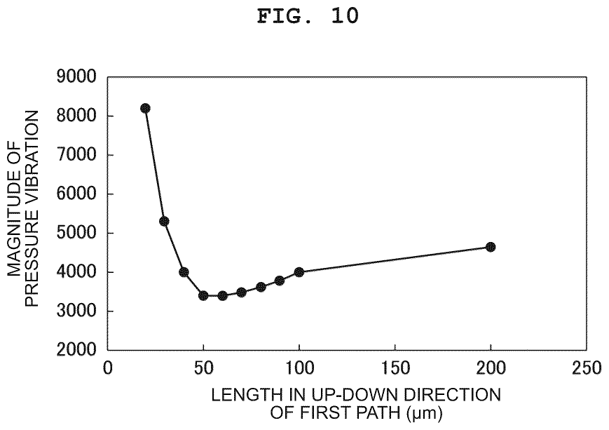

From the foregoing, the absolute value of the pressure at each of the measurement positions P1 to P5 are integrated in the direction of the time so as to derive values SP1, SP2, SP3, SP4, and SP5; and the average value of the values SP1, SP2, SP3, SP4, and SP5 is defined as the magnitude of the pressure vibration in the common channel 12. Further, the magnitude of the pressure vibration is derived, with the length in the up-down direction D3 of the first path 113 being within a range of 20 μm to 200 μm. Further, a relationship between the derived length in the up-down direction D3 of the first path 113 and the magnitude of the pressure vibration is indicated in FIG. 10. In FIG. 10, the vertical axis indicates the magnitude of pressure vibration, and the horizontal axis indicates the length in the up-down direction D3 of the first path 113. As indicated in FIG. 10, in a case where the length in the up-down direction D3 of the first path 113 is 20 μm, the magnitude of the pressure vibration in the common channel 12 is the greatest. On the other hand, in a case where the length in the up-down direction D3 of the first path 113 is in a range of 50 μm to 60 μm, the magnitude of the pressure vibration in the common channel 12 is the smallest.

Here, the length in the up-down direction D3 of the first path 113 is normalized by the channel resistance of the first path 113. Since the planar channel shape of the first path 113 is rectangular, the following mathematical expression of channel resistance R of a rectangular flow channel is used.

The channel resistance R is given as follows.

$$\begin{matrix}R = \frac{64 η L}{{ab}^{3} X} \\ where X = \frac{16}{3} - \frac{1024}{{π}^{5}} \frac{b}{a} ( tan h \frac{π a}{2 b} + \frac{1}{{3}^{5}} tan h \frac{3 π a}{2 b} + … )\end{matrix}$$

In the mathematical expression, “n” is the viscosity of the liquid; “a” is the length in the second direction D2 of the first path 113; “b” is the length in the up-down direction D3 of the first path 113; and “L” is the length in the first direction D1 of the first path 113.

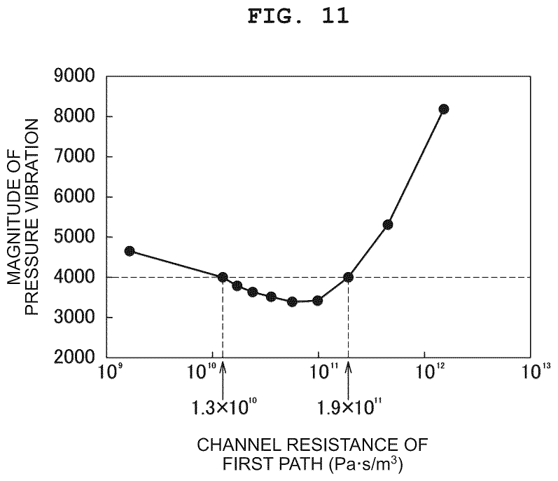

FIG. 11 indicates the relationship between the value derived from the above-described mathematical expression of the channel resistance R and the magnitude of the pressure vibration. In FIG. 11, the vertical axis indicates the magnitude of the pressure vibration, and the horizontal axis indicates the channel resistance. As appreciated from FIG. 11, in a case where the magnitude of the pressure vibration is 4000 or less, the channel resistance R is in the range of 1.3×10¹⁰ Pa·s/m³ to 1.9×10¹¹ Pa·s/m³. In the case where the magnitude of the pressure vibration is 4000 or less, the pressure vibration in the common channel 12 can be attenuated more effectively. Therefore, the channel resistance of the first path 113 in the present embodiment is set to be in the range of 1.3×10¹⁰ Pa·s/m³ to 1.9×10¹¹ Pa·s/m³.

As described above, according to the head 1 of the present embodiment, the ink is supplied to the common channel 12 from the both end parts in the first direction D1 of the common channel 12, and the ink in the common channel 12 flows to the plurality of individual channels 13. In this situation, the pressure wave generated in the common channel 12 is attenuated in a case where the pressure wave passes through the first path 113 having the large channel resistance. Therefore, the pressure vibration generated in common channel 12 can be attenuated.

Further, since the channel resistance of the first path 113 is in the range of 1.3×10¹⁰ Pa·s/m³ to 1.9×10¹¹ Pa·s/m³, the pressure wave generated in the common channel 12 can be effectively attenuated in a case where the pressure wave passes through the first path 113.

Furthermore, the cross-sectional area S2 of the second path 115 is the same as the cross-sectional area S3 of the common part 114. Owing to this, the ink can be smoothly supplied from the second path 115 to the common part 114. Therefore, any unsatisfactory supply of the ink to the plurality of individual channels 13 is less likely to occur, while attenuating the pressure wave in the first path 113.

Moreover, the damper 28A is disposed along the bottom surface 12B of the common channel 12. This improves the attenuating effect of the pressure wave generated in the common channel 12.

Further, the first paths 113 of the two common channels 12 are disposed on the opposite sides of each other in the first direction D1, with the common parts 114 of the two common channels 12 interposed between the first paths 113 of the two common channels 12. As a result, even in a case where the amount of the ink ejected from the nozzle 15, at the other end in the first direction D1 (at a location adjacent to the lower end in FIG. 3), which communicates with the one common channel 12 (left side in FIG. 3), is less than the amount of the ink ejected from the nozzle 15, at the one end in the first direction (at a location adjacent to the upper end in FIG. 3), which communicates with the one common channel 12, the amount of the ink ejected from the nozzle 15 at the other end in the first direction D1, which communicates with the other common channel 12 (right side in FIG. 3) adjacent to the one common channel 12, is greater than the amount of the ink ejected from the nozzle 15, at the one end in the first direction D1, which communicates with the other common channel 12. Accordingly, in the head 1, the unevenness in the first direction D1 in the amount of the ink ejection from the plurality of nozzles 15 is reduced.

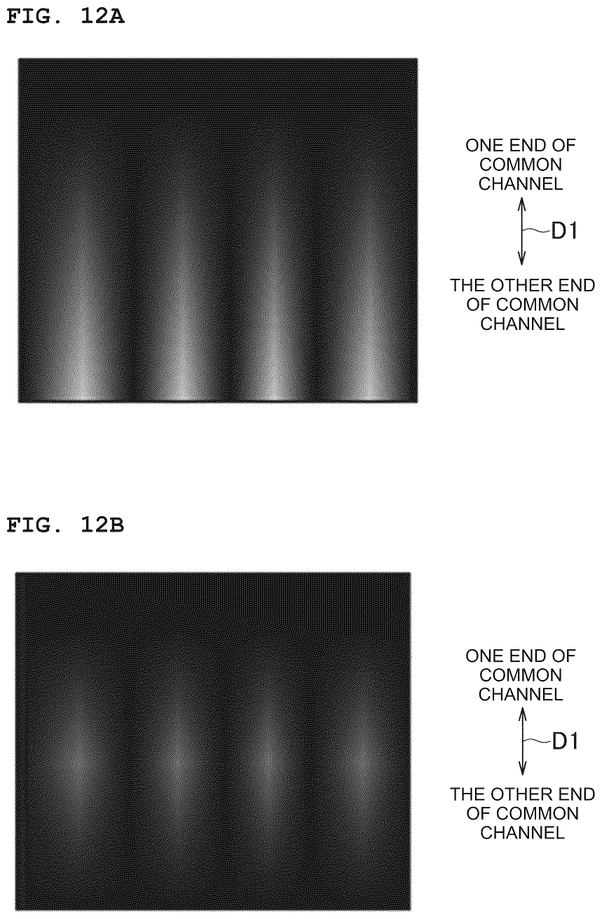

In such a presumed case where the first paths 113 of the two common channels 12 are disposed at the location adjacent to the other end in the first direction D1, the pressure vibration in both of the two common channels 12 becomes greater at a location closer to each of the first paths 113. The ink ejection amount from the nozzles 15 which communicate with a location at which the pressure vibration is great is easily affected by the pressure vibration. For example, in a case where the ink ejection amount from the nozzles 15 becomes smaller as the pressure vibration becomes greater, the ink ejection amount becomes smaller at a nozzle 15, among the nozzles 15, which is located closer to the other end of each of the two common channels 12. FIG. 12A depicts an image subjected to solid printing by ejecting the ink from all the nozzles of a head in which the first paths 113 of the two common channels 12 are disposed at the location adjacent to the other end in the first direction D1. On the other hand, FIG. 12B depicts an image subjected to the solid printing by ejecting ink from all the nozzles of the head 1 in the present embodiment. In this case, as depicted in FIG. 12A, the ink amount becomes smaller further at a location closer to the other end of the common channel 12, and a striped pattern becomes more conspicuous. In the present configuration, the first paths 113 of the two common channels 12 are disposed on the opposite sides of each other in the first direction D1. Owing to this, any unevenness in the ink ejection amount from the nozzles 15 in the first direction D1 can be avoided, as described above. As a result, the stripe pattern is less conspicuous, as depicted in FIG. 12B.

According to the printer 100 of the present embodiment, the controller 5 controls the two pressure pumps 10 and 11 so that the ink is supplied to the inflow ports 12A1 and 12A2 of the common channel 12 at the same pressure during the printing. This reduces the pressure difference between an individual channel 13 disposed closely to the inflow port 12A1 and another individual channel 13 disposed closely to the inflow port 12A2 in the head 1. Accordingly, the ejecting characteristic from the nozzles 15 becomes stable.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above-described embodiment, the first path 113 may have a channel resistance outside the range of 1.3×10¹⁰ Pa·s/m³ to 1.9×10¹¹ Pa·s/m³ as long as the cross-sectional area S1 of the first path 113 is smaller than the cross-sectional area S2 and the cross-sectional area S3, respectively, of the common part 114 and the second path 115. Further, the cross-sectional area S3 of the common part 114 and the cross-sectional area S2 of the second path 115 may be different from each other.

In the above-described embodiment, although the damper 28A is disposed along the bottom surface 12B of the common channel 12 of the head 1, the damper 28A may be omitted. The first path 113 may be disposed below and away from the upper surface 12A of the common channel 12.

Furthermore, the head 1 may include one common channel 12 or three or more common channels 12. In a case where the head 1 has the plurality of common channels 12, the first path 113 may be disposed in one side in the first direction D1 of each of the common channels 12.

Moreover, the printer 100 may include only one pressure pump 10 or 11. Further, in a case where the head 100 includes three or more common channels 12, the printer 100 may include three or more pressure pumps, each corresponding to one of the three or more common channels 12.

In the above-described embodiment, although the electrode constructing the actuator part 35 has a two-layered structure including the individual electrode and the common electrode, the electrode may have a three-layered structure. The term “three-layered structure” means, for example, a structure including a driving electrode to which a high potential and a low potential are selectively applied, a high potential electrode maintained at the high potential and a low potential electrode maintained at the low potential.

The type of the liquid ejecting head of the present disclosure is not limited to the liquid ejecting head of the line type, but may also be a liquid ejecting head of the serial type.

The object to which the liquid is ejected is not limited to the sheet, and may be, for example, a cloth, a substrate, or a plastic member.

The liquid ejected from the nozzles is not limited to the ink. For example, the liquid may be, for example, a treatment liquid which agglutinates or precipitates a component in the ink.

The liquid ejecting apparatus of the present disclosure is not limited to being applicable to the printer, and is applicable also to facsimiles, copy machines, multi-function peripherals, etc. Further, the present disclosure is applicable also to a liquid ejecting head and a liquid ejecting apparatus each of which is used for any application other than the recording of an image. For example, the present disclosure is applicable to a liquid ejecting head and a liquid ejecting apparatus each of which forms an electroconductive pattern by ejecting an electroconductive liquid to a substrate.

What is claimed is:

1. A liquid ejecting head comprising:
a common channel extending in a first direction orthogonal to an up-down direction; and
a plurality of individual channels each including a nozzle and a pressure chamber communicating with the nozzle, the plurality of individual channels being aligned in the first direction, and each of the plurality of individual channels communicating with the common channel, wherein
the common channel includes:
a first supply port disposed at one end of the common channel in the first direction;
a second supply port disposed at the other end of the common channel in the first direction;
a first path disposed between the first supply port and a first connecting portion in the first direction, the first connecting portion being a connection between the common channel and one of the plurality individual channels disposed closest to the one end of the common channel; and
a second path disposed between the second supply port and a second connecting portion in the first direction, the second connecting portion being a connection between the common channel and one of the plurality individual channels disposed closest to the other end of the common channel,
a cross-sectional area of the first path in the common channel orthogonal to the first direction is smaller than a cross-sectional area of the second path in the common channel orthogonal to the first direction, and
the cross-sectional area of the first path in the common channel orthogonal to the first direction is smaller than a cross-sectional area of a part of the common channel between the first connecting portion and the second connecting portion.

2. The liquid ejecting head according to claim 1, wherein
channel resistance of the first path is not less than 1.3×10¹⁰ Pa·s/m³ and is not more than 1.9×10¹¹ Pa·s/m³.

3. The liquid ejecting head according to claim 1, wherein
the cross-sectional area of the second path orthogonal to the first direction is equal to the cross-sectional area of the part of the common channel orthogonal to the first direction.

4. The liquid ejecting head according to claim 1, wherein
the first path is disposed along an upper surface of the common channel.

5. The liquid ejecting head according to claim 1, further comprising a damper disposed along a bottom surface of the common channel and configured to absorb pressure vibration of the liquid in the common channel.

6. The liquid ejecting head according to claim 1, wherein
a plurality of common channels, including the common channel, are lined up next to each other in a second direction orthogonal to both the first direction and the up-down direction, and
two adjacent common channels in the plurality common channels are adjacent to each other in the second direction,
the part of the common channel between the first connecting portion and the second connecting portion is disposed between the first path of one of the two adjacent common channels and the first path of the other of the two adjacent common channels in the first direction.

7. A liquid ejecting apparatus comprising:
a head including:
a common channel extending in a first direction orthogonal to an up-down direction; and
a plurality of individual channels each including a nozzle and a pressure chamber communicating with the nozzle, the plurality of individual channels being aligned in the first direction, and each of the plurality of individual channels communicating with the common channel;
a supplying part; and
a controller; wherein
the common channel includes:
a first supply port disposed at one end of the common channel in the first direction;
a second supply port disposed at the other end of the common channel in the first direction;
a first path disposed between the first supply port and a first connecting portion in the first direction, the first connecting portion being a connection between the common channel and one of the plurality individual channels disposed closest to the one end of the common channel; and
a second path disposed between the second supply port and a second connecting portion in the first direction, the second connecting portion being a connection between the common channel and one of the plurality individual channels disposed closest to the other end of the common channel,
a cross-sectional area of the first path in the common channel orthogonal to the first direction is smaller than a cross-sectional area of the second path in the common channel orthogonal to the first direction,
the cross-sectional area of the first path in the common channel orthogonal to the first direction is smaller than a cross-sectional area of a part of the common channel between the first connecting portion and the second connecting portion, and
the controller is configured to control the supplying part so that a pressure applied to the first supply port for supplying the liquid is equal to a pressure to the second supply port for supplying the liquid.
